(19) United States
(12) Patent Application Publication
(10) Pub. No.: US 2009/0284003 A1
(43) Pub. Date: Nov. 19, 2009

(54) Technical note-taking paper

(76) Inventor: Jeffrey Jorgensen, Treynor, IA (US)

Correspondence Address: THOMTE LAW OFFICE, L.L.C., 2120 S. 72ND STREET, SUITE 1111, OMAHA, NE, 68124, US

(21) Appl. No.: 12/386,981

(22) Filed: Apr. 24, 2009

Related U.S. Application Data
(60) Provisional application No. 61/053,963, filed on May 16, 2008.

(51) Int. Cl. B42D 15/00

(52) U.S. Cl. 283/115

(57) ABSTRACT

An improved technical note-taking paper is disclosed and which includes first and second sides, the first side including printed indicia of a plurality of equidistantly spaced parallel horizontal lines which extend across the page to the left and right margins, at least one vertical column formed by at least one vertical line intersecting and extended perpendicular to each of the horizontal lines and a topmost title box, the second side of the page including printed indicia of a plurality of intersecting vertical and horizontal lines forming a rectangular graph, the spacing and alignment of the horizontal lines on the second side of the page being identical to the spacing and alignment of the horizontal lines on the first side of the page, the paper being used with the present invention being marginally translucent such that the graph arrangement on the second side of the page is at least marginally visible through the first side of the page so that the user of the present invention may utilize the graph design on the second side for alignment of diagrams and the like while taking notes on the horizontal lines of the first side of the page.

### CROSS REFERENCE TO RELATED APPLICATION

This application claims the benefit of provisional patent application Ser. No. 61/053,963, filed May 16, 2008, entitled IMPROVED TECHNICAL NOTE-TAKING PAPER.

### BACKGROUND OF THE INVENTION

1. Field of the Invention

This invention relates to note-taking paper and more particularly to an improved technical note-taking paper.

2. Description of the Related Art

A vast majority of engineers and engineering students take notes on graph paper which usually includes a set of intersecting horizontal and vertical lines which form the graph printed on the paper on which the notes are being taken. In general, the spacing between the horizontal and vertical lines is approximately equal, thus resulting in a series of squares covering the paper. One of the drawbacks of using graph paper, however, is that there are many situations where standard horizontal-lined paper would be preferable for note-taking purposes, yet during the same session or lecture, diagrams and charts may need to be added to the notes, and it is during this time that the presence of the perpendicular vertical lines and horizontal lines is beneficial. Although there are examples of note-taking paper which include sections of horizontal ruled lines and graph sections printed on the same side of the paper, these are of limited value because the sectioning of the notepaper necessarily restricts the amount and size of notes which may be taken, and note-taking flexibility is thus severely restricted. There is therefore a need for an improved note-taking paper which will facilitate standard note-taking on horizontal lines, yet simultaneously will provide marginally visible vertical reference lines to facilitate the addition of diagrams, charts and hand-drawn pictures to the standard notes being taken.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The present invention is directed to various types of note-taking paper and, more particularly, to an improved technical note-taking paper which includes first and second sides, the first side including printed indicia of a plurality of equidistantly spaced parallel horizontal lines which extend across the page to the left and right margins, at least one vertical column formed by at least one vertical line intersecting and extended perpendicular to each of the horizontal lines and a topmost title box, the second side of the page including printed indicia of a plurality of intersecting vertical and horizontal lines forming a rectangular graph, the spacing and alignment of the horizontal lines on the second side of the page being identical to the spacing and alignment of the horizontal lines on the first side of the page, the paper being used with the present invention being marginally translucent such that the graph arrangement on the second side of the page is at least marginally visible through the first side of the page so that the user of the present invention may utilize the graph design on the second side for alignment of diagrams and the like while taking notes on the horizontal lines of the first side of the page.

It is therefore a principal object of the invention to provide an improved technical note-taking paper.

### BRIEF DESCRIPTION OF THE DRAWINGS

Non-limiting and non-exhaustive embodiments of the present invention are described with reference to the following Figs., wherein like reference numerals refer to like parts throughout the various views unless otherwise specified.

FIG. 1 is a perspective view of the improved technical note-taking paper showing how the graph design on the second side of the page is marginally visible through the first side of the page;

FIG. 2 is a perspective view of the second side of the page showing the graph design printed thereon; and

FIG. 3 is a perspective view of the first side of the page showing the note-taking design printed thereon.

### DESCRIPTION OF THE PREFERRED EMBODIMENT

Embodiments are described more fully below with reference to the accompanying Figs., which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

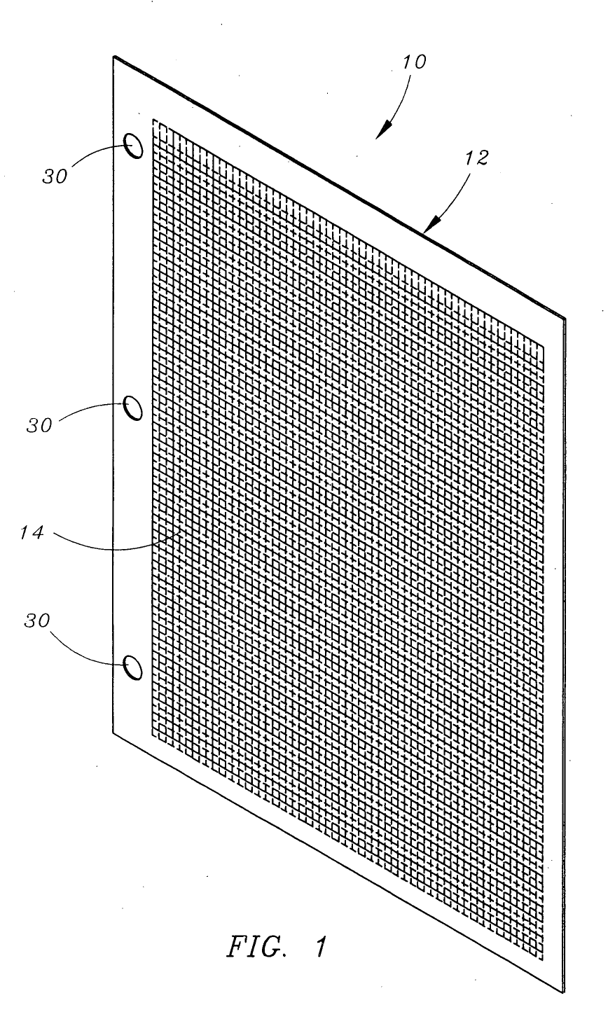

The improved technical note-taking paper 10 of the present invention is shown best in FIGS. 1-3 as including a sheet of paper 12 which, in the preferred embodiment, would be of a standard size and shape, namely 8½ inches by 11 inches, although modification of the size of the sheet of paper 12 is well within the purview of the present disclosure. The important consideration in the construction material used for the paper is that the paper 12 must be sufficiently translucent to permit dim viewing of imprinted indicia on the opposite side of the sheet of paper 12 when the sheet of paper 12 is viewed in the correct light orientation. It has been found that a standard 20 pound thickness white, cream or yellow paper will be suitable for the intended purposes of the present invention, although some variation from this thickness of paper will also be suitable for use with the present invention. The key consideration, however, is that printed indicia on the opposite side of the sheet of paper 12 from the viewer is at least dimly visible through the sheet of paper 12, the significant reasons for which will be described later in this disclosure.

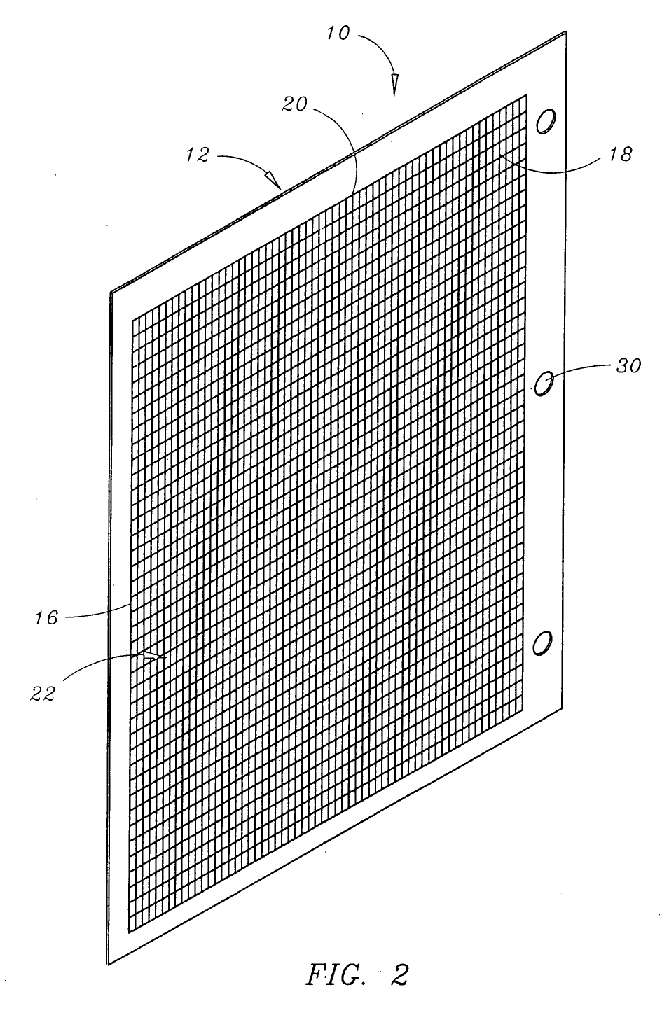

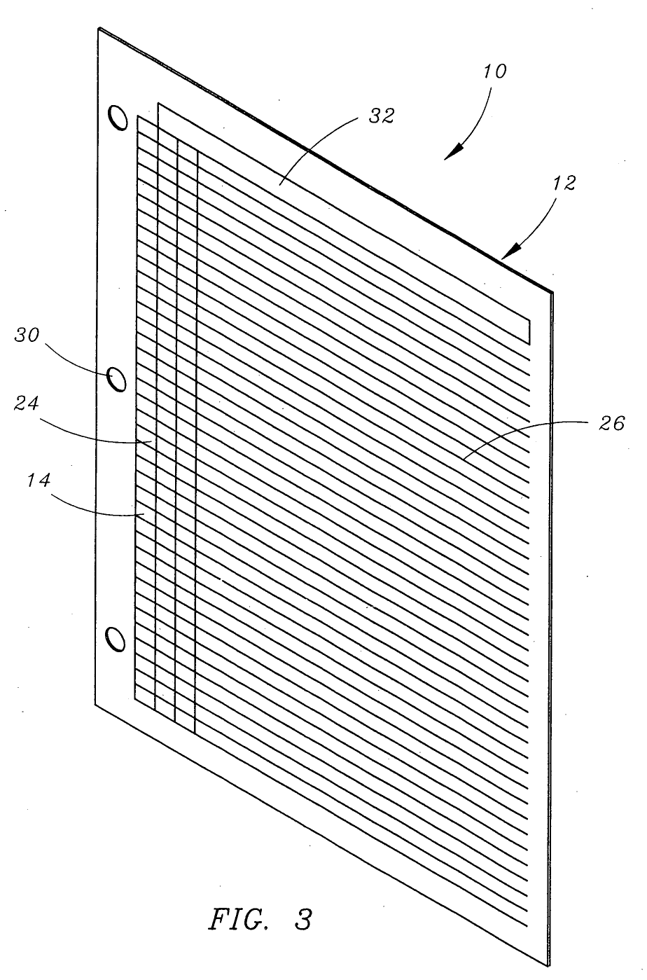

The printed elements of the improved technical note-taking paper 10 of the present invention are shown best in FIGS. 2 and 3, with the front side 14 of the sheet of paper 12 being shown best in FIG. 3 and the back side 34 of the sheet of paper 12 being shown best in FIG. 2. FIG. 3 illustrates how the front side 14 of the sheet of paper 12 would have a plurality of spaced horizontal lines 16 formed extending left to right across the sheet of paper 12 and would preferably be spaced approximately ¼ inches to ⅝ inches apart vertically, with the lines 16 each having a length of approximately one to two inches less than the width of the sheet of paper 12. In the preferred embodiment, the horizontal line 16 would be printed in a dark ink color, be it black, gray, blue or any other such dark color which clearly delineates the horizontal lines 16 on the front side 14 of the sheet of paper 12.

Extending vertically perpendicular to the horizontal line 16 are a plurality of vertical lines 18 which create a plurality of vertical columns 20 adjacent the left-hand side 22 of front side 14, as shown best in FIG. 3. Finally, across the top of front side 14 is a title bar 22 which, in the preferred embodiment, would be a rectangular box formed at the top of front side 14 and extending generally across the width of the horizontal lines 16. It should be noted that neither of these features is particularly critical to the proper functioning of the present invention, and in fact may be modified or changed to show other arrangements of lines, but it is generally preferred that the present invention include these features as it has been determined that they generally facilitate note-taking procedures. For purposes of description, sheet 12 will be described as having a front side 14 and a back side 16. Also, additional vertical lines may be used on the present invention to provide further divisions of the front side 14 of the paper, and these lines may be solid, dashed, or in different colors depending on the specific design desired by the manufacturer or user of the improved technical note-taking paper 10 of the present invention. These could be spaced from the leftmost vertical lines, or aligned at virtually any location on the front side 14 of the paper, and the orientation and positioning of these additional vertical lines would be determined by the intended use of the improved technical note-taking paper 10 of the present invention.

The back side 16 of sheet of paper 12 is shown best in FIG. 2 as including a plurality of horizontal lines 18 and a plurality of perpendicular vertical lines 20 which combine to form the graph design 22 which is shown on FIG. 2. It is further preferred that the margins used on the back side 16 be equal to the margins used on the front side 14, so that the left, right, bottom and top edges of the graph 22 are aligned on the back side 16 with the left-most vertical line 24, right edges of the horizontal lines and the top and bottom horizontal lines 26 on the front side 14 of the sheet of paper 12, as shown best in FIG. 1. Additionally, it should be noted that the spacing of the horizontal lines 18 on back side 16 and the spacing of the horizontal lines 26 on front side 14 are identical and align with one another so that the horizontal lines, when viewed on the front or back of the sheet of paper 12, appear as single lines rather than double lines, due to the marginally translucent nature of the sheet of paper 12. Likewise, although the vertical lines 24 on front side 14 of the sheet of paper 12 are preferably spaced apart horizontally more than the vertical liens 20 on back side 16, it should be noted that each of the vertical lines 24 align with one of the vertical lines 20 on the back side and thus these vertical lines 24 and 20 appear as single lines when the sheet of paper 12 is viewed from either the front side 14 or back side 16.

The significant benefit of the alignment of the horizontal lines 26 and 18 and vertical lines 24 and 20 is that when the front side 14 of the sheet of paper 12 is being viewed, the vertical lines 20 on the back side 16 are marginally visible through the somewhat translucent sheet of paper 12, and thus the vertical lines 20 may be used by the person taking notes to align Figs., charts and other such hand-drawn graphical representations of information, yet when standard note-taking in the form of alphanumeric characters is being undertaken, the horizontal lines 26 on the front side 14 of sheet of paper 12 are the most clearly visible and discernable, and therefore, in this situation, the improved technical note-taking paper 10 acts as a standard ruled sheet of paper. In effect, graph paper is available for those situations requiring use of graph paper for alignment of graphical representations of information and lined or ruled paper is available when standard note-taking techniques are being performed, and these two seemingly contrasting scenarios are available simultaneously through the configuration and orientation of the improved technical note-taking paper 10 of the present invention. It is believed that this combination of horizontal and vertical alignment of the horizontal lines 26 and 18 and vertical lines 24 and 20 on the front and back sides 14 and 16 of the sheet of paper 12, combined with the marginal translucence of the sheet of paper 12, render the present invention unique over the prior art note-taking papers presently available, and therefore it is believed that the present invention is deserving of protection.

It is to be understood that numerous additions, modifications and substitutions may be made to the improved technical note-taking paper 10 of the present invention which fall within the intended broad scope of the above description. For example, two, three or more holes 30 may be formed in the sheet of paper 12 along one side thereof to allow the sheet of paper 12 to be added to a binder (not shown) or the like, as per a standard sheet of notebook paper. Furthermore, it is preferred in the present invention that the title bar 32 and at least one of the vertical lines 24 on the front side 14 of the sheet of paper 12 be distinguished by use of a different ink color, such as red or blue, to provide additional visual references and note-taking cues for persons using the improved technical note-taking paper 10 of the present invention. It should be noted, however, that the precise colors and line thicknesses used for the present invention are not particularly critical so long as the alignment of the horizontal and vertical lines and marginal translucence of the sheet of paper 12 are generally maintained. Finally, it should be noted that the construction material used in connection with the improved technical note-taking paper 10 of the present invention may be either modified or changed so long as the translucence of the construction material generally permits marginal viewing of the horizontal and vertical lines 18 and 20 on back side 14 through the sheet of paper 12 when the sheet of paper is in a preferred orientation relative to a light source.

There has therefore been shown and described an improved technical note-taking paper 10 which accomplishes at least all of its intended purposes.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A technical note-taking paper, comprising:
a sheet of paper having a front side and a back side;
said back side of said sheet of paper having a plurality of equally spaced-apart horizontal lines formed therein and a plurality of equally spaced-apart vertical lines formed therein which combine to form a graph design;
said first side of said sheet of paper having a plurality of equally spaced-apart horizontal lines formed therein which are in alignment with said horizontal lines on said back side of said sheet of paper;
said sheet of paper being sufficiently translucent such that the graph design on said back side of said sheet of paper is at last partially visible from the front side of said sheet of paper so the user of the sheet of paper may utilize the graph design on the said back side of said sheet of paper for alignment of diagrams and the like while taking notes on the said horizontal lines on said front side of said sheet of paper.

2. The technical note-taking paper of claim 1 wherein the alignment of said horizontal lines on said back side of said sheet of paper with said horizontal lines on said front side of said sheet of paper prevents said horizontal lines on said back side of said sheet of paper from being visible from said front side of said sheet of paper.

3. The technical note-taking paper of claim 1 wherein at least some equally spaced-apart lines are formed on said front side of said sheet of paper which are in alignment with at least some of said vertical lines on said back side of said sheet of paper.

4. The technical note-taking paper of claim 3 wherein said front side of said sheet of paper has a left margin and wherein said vertical lines on said front side of said sheet of paper are positioned adjacent said left margin.

5. The technical note-taking paper of claim 1 wherein a title bar is formed on said front side of said sheet of paper.
